(19) United States
(12) Patent Application Publication
(10) Pub. No.: US 2007/0122524 A1
(43) Pub. Date: May 31, 2007

(54) Bread yeast resistant to a high sugar concentration in the dough and to the presence of weak organic acids

(75) Inventors: Didier Colavizza, Euralille (FR); Annie Loiez, Lille (FR); Jean-Charles Bartolucci, Saint Andre Lez Lille (FR); Anne-Dominique Quipourt-Isnard, Marcq-en-Baroeul (FR)

Correspondence Address: SUGHRUE MION, PLLC, 2100 PENNSYLVANIA AVENUE, N.W., SUITE 800, WASHINGTON, DC, 20037, US

(73) Assignee: LESAFFRE ET COMPAGNIE

(21) Appl. No.: 10/587,864

(22) PCT Filed: Jan. 28, 2005
(86) PCT No.: PCT/EP05/00860

§ 371 Date: Jul. 28, 2006

(30) Foreign Application Priority Data
Jan. 30, 2004 (EP) 04002032.3

(51) Int. Cl. A21D 8/02

(52) U.S. Cl. 426/19

(57) ABSTRACT

The invention relates to bread yeast strains that are effective in dough with a high sugar concentration, optionally in the presence of fungus inhibitors, to fresh or dry bread yeast obtained from said strains, and to those thereof in bread-making.

### FIELD OF THE INVENTION

The invention relates to novel strains of bread-making yeasts, also called baker's yeasts, that are effective in dough with a high sugar concentration, optionally in the presence of mould inhibitors. The invention also relates, to fresh or dry baker's yeasts as novel industrial products obtained from said strains, and to use thereof in bread-making.

### DESCRIPTION OF THE STATE OF THE ART

Currently, bread products with a more or less high sugar concentration and/or containing mould inhibitors account for a large share of the worldwide market. There exist so-called “rapid” baker's yeast strains, adapted to dough with little or no sugar, that is to say, containing no more than 7% of sugar by mass relative to the mass of the flour. The fermentative performances of said yeasts are sharply reduced when the sugar concentration of the dough reaches or exceeds 15% by mass relative to the mass of flour.

Baked bread products, particularly when sold sliced, are vulnerable to the growth of mould after a few days of storage. Consequently, during the production of breads to be sliced, it is often necessary to add to the bread composition antifungal and anti-mould agents belonging to the family of weak organic acids (having a pKa from 3 to 6) and the salts thereof, such as acetic acid, propionic acid, sorbic acid or the salts thereof, or other preservatives classically used in bread-making.

Said acids have a more or less strong inhibitory effect on bread-making yeasts. In practice, calcium propionate is the most widely used mould inhibitor in bread-making.

### DEFINITION OF THE INVENTION

The invention makes it possible to at least partially palliate the inhibitory effects of a high concentration of sugar(s) in the dough, optionally in the presence of a mould inhibitor such as described hereinabove. The invention relates to novel strains of bread-making yeast, and more generally to a novel family of bread-making yeast strains, corresponding to yeasts which are effective in sweet doughs, to which mould inhibitors such as weak organic acids and/or the salts thereof have been added or not. Thanks to the different yeasts strains belonging to said family, the proof time, measured in different bread recipes, is reduced by the use of one of said novel strains. Proof time is a commonly used parameter in bread-making. It is defined as the time required for the bread-making dough to rise to a given height in the pan and be ready for baking. One of the novel strains of Saccharomyces cerevisiae so obtained was deposited in accordance with the Budapest treaty on Feb. 12, 2003, in the CNCM (Collection Nationale de Cultures des Microorganismes at the Pasteur Institute, 25 rue du Dr. Roux, F-75724 Paris Cedex 15, France) under the number I-2971.

Two other novel Saccharomyces cerevisiae strains so obtained were deposited in the CNCM on Nov. 25, 2003, under the numbers I-3142 and I-3143. The invention relates to the three aforementioned strains and to all strains belonging to the same family, that is to say, all strains which share the same properties as the three aforementioned strains, as well as all strains which can be derived from said family of strains, and in particular from the three deposited strains, by any transformation whatsoever, such as for example by one or more cross-hybridizations, by mutation (spontaneous or induced) and by genetic transformation.

As above indicated, the advantages of the strains according to the invention are expressed in particular when the baker's yeasts obtained by cultivating said strains are used as leavening agent in dough with a high sugar concentration and optionally containing mould inhibitors such as a weak organic acid and/or the salt thereof. The baker's yeasts obtained with the strains according to the invention can be of particular interest in:
bread-making methods of the type NO-TIME DOUGH and SPONGE and DOUGH with doughs containing between 12% and 28% of sugar in baker's percentage, with or without mould inhibitor,
bread-making methods of the type NO-TIME DOUGH and SPONGE and DOUGH with doughs containing between 12% and 18% of sugar in baker's percentage, and a mould inhibitor, or
bread-making methods of the type NO-TIME DOUGH and SPONGE and DOUGH with doughs containing between 28% and 45% of sugar in baker's percentage, with or without mould inhibitor.

The usefulness of the strains according to the invention is not limited to the specific applications cited hereinabove.

The invention also relates to baker's yeasts obtained by cultivating a strain according to the invention, and in particular to said yeasts adapted to the presence of a weak organic acid, in particular by an adaptation method such as described hereinbelow.

The baker's yeast according to the invention can be a yeast cream, a compressed yeast or a dry yeast. When the yeast according to the invention is a dry yeast, it is preferably an instant dry yeast.

The invention also relates to bread-making doughs or baker's doughs containing a baker's yeast according to the invention. The doughs according to the invention can contain at least 15% of sugar relative to the mass of flour, preferably at least 25% of sugar relative to the mass of flour. In particular, they can contain 40% or more of sugar relative to the mass of flour. More generally, the doughs according to the invention can be doughs in which fermentation takes place under an osmotic pressure such as that existing in doughs containing at least 15% of sugar relative to the mass of flour, preferably at least 25% of sugar relative to the mass of flour, or even 40% or more of sugar relative to the mass of flour. Said doughs according to the invention can also contain mould inhibitors, preferably in the form of weak organic acids and/or the salts thereof, and more preferably in the form of propionates, such as calcium propionate.

The invention also relates to a method for preparing a bread-making dough in which a yeast according to the invention is used as a leavening agent. The invention also relates to a method for preparing a baked bread product in which one bakes a bread-making dough according to the invention, and to the bread products thus obtained.

### DETAILED DESCRIPTION OF THE INVENTION

The invention is directed at providing strains which, after industrial culture, give a bread-making yeast having a very high tolerance to sugar, or else a very high tolerance to a high osmotic pressure, in the presence or not of at least one mould inhibitor, that is to say, yeast strains adapted to high concentrations of saccharose, glucose, fructose, or else a mixture of said sugars and optionally of other fermentescible sugars, in the presence or not of calcium propionate for example.

The yeasts which are the object of the invention were obtained by systematically cross-hybridizing strains used to produce commercial bread-making yeasts (commercial strains) or strains from public collection centers known to have high osmotolerance property and commercial strains or strains from public collection centers known to be fairly osmotolerant and low sensitive to the presence of weak organic acids or the salts thereof, used as mould inhibitors. The sporulation and hybridization program was carried out according to conventional techniques, such as those found in the teachings of chapter 7 entitled “Sporulation and Hybridization of Yeast” by R. R. Fowell, of the reference work “The Yeasts”, Volume 1, A. H. Rose and J. S. Harrison, Editors, 1969, Academic Press.

Strains obtained through said hybridization program were multiplied in the laboratory by conventional methods, with adaptation to the presence of weak organic acid(s), as in the teachings of U.S. Pat. No. 4,318,991, with addition of 0.1 g to 10 g of short chain aliphatic carboxylic acids, such as aliphatic carboxylic acids having 2, 3 or 4 carbon atoms, and/or the salts thereof, per liter of wort.

The yeasts so obtained from strains arising from the aforementioned hybridization program were selected by bread-making tests using the NO-TIME DOUGH process, i.e. a direct process. Said process contains virtually no first fermentation step between intensive kneading and division of the dough, the dough pieces obtained being fermented in the pan between 35° C. and 40° C., then baked. This latter fermentation, which is the main fermentation in such a process, is called “proof” in English, “apprêt” in French. The proof time is defined as the time required for the dough to rise to a given height in the pan, corresponding to the development of the desired dough so that it can be placed in the oven.

The variables in said bread-making tests were as follows:
percentage of sugar by mass relative to the flour;
percentage of calcium propionate by mass relative to the flour;
percentage of yeast dry matter content, by mass, relative to the flour.

All percentages are expressed as so-called baker's percentages, the so-called baker's percentage being a method of calculation applied to ratios of ingredients in which the total mass of the flour always represents 100% and the mass of the other ingredients of the dough is calculated in relation to this mass of flour. The control dough was a dough obtained in the same conditions and with a same composition, the difference being that it was seeded with a yeast produced in the same conditions as the tested strains, with adaptation to the presence of weak organic acid(s), but in this case obtained with the baker's yeast strain NCYC 996, deposited in the NCYC (National Collection of Yeast Cultures, Institute of Food Research, Norwich Research Park, Colney, Norwich, NR4 7UA, United Kingdom), and described in particular in U.S. Pat. No. 4,396,632. For the past twenty years, this strain has served as the reference strain in order to obtain commercial baker's yeasts effective on sweet doughs containing or not containing mould inhibitors.

It should be reminded that reference to a control is essential to check the proper conduct of any test aiming to measure the activity of a baker's yeast, whether said activity be expressed as CO₂ release or by another parameter such as proof time.

The selection criteria used in a first selection were at least two of the following three criteria, and preferably all three criteria combinated together:
1. in a dough containing 15% of sugar (baker's percentage) with or without addition of 0.4% of calcium propionate (baker's percentage), the selected strains correspond to baker's yeasts which give a proof time at least equivalent, that is to say, less than or equal to, the proof time obtained with the control;
2. in a dough containing 25% of sugar (baker's percentage) and 0.4% of calcium propionate (baker's percentage), the selected strains correspond to baker's yeasts which give a proof time at least 5% lower and preferably at least 10% lower than the proof time obtained with the control;
3. in a dough containing 40% of sugar (baker's percentage), the selected strains correspond to baker's yeasts which give a proof time at least 20% lower, preferably at least 30% lower and even more preferably at least 35% lower than the proof time of the control.

The following two selection criteria were used in a second selection as a complement and in combination with the three aforementioned criteria, the selected strain additionally having to meet one of these two additional criteria:
1. The baker's yeasts obtained with a strain arising from the first selection must be resistant to drying. In other words, in the drying conditions described in patent EP 0511108 or in U.S. Pat. No. 5,741,695, they must not lose more than 30% of their fermentative activity, for a constant dry matter content, as measured with a Burrows and Harrison fermentor in tests A₅, A′₅, A₆, A′₆ described in the aforementioned patent EP 0511108 or in U.S. Pat. No. 5,741,695, said drying conditions and said tests being described hereinbelow.
2. The baker's yeasts obtained with a strain arising from the first selection, in a SPONGE and DOUGH process such as defined in the reference book entitled “Baker's Handbook” by E. J. Pyler, published by Sosland Publishing Co., characterized by a DOUGH step comprising the addition of 25% of saccharose by mass relative to the total flour mass employed in SPONGE and DOUGH, give, in relation to a DOUGH obtained in the same conditions and seeded with a baker's yeast obtained in the same conditions with the strain NCYC 996, a proof time which is at least 20% lower, preferably at least 30% lower, and even more preferably at least 40%.

In the above definition, a “SPONGE and DOUGH” process is a common bread-making method with two fermentation steps:
a first step, or SPONGE, which corresponds to the fermentation, for several hours, generally about four hours, of a dough comprising 50 to 70% of the total quantity of flour employed, part of the water and all of the yeast,
a second step, or DOUGH, in which the SPONGE, following the aforementioned fermentation, is combined with the remainder of the flour, the remainder of the water and the other ingredients of the dough (including all the saccharose). The resulting mixture is kneaded, divided, placed in the pan and fermented, said second fermentation in the pan corresponds to the proof, the duration thereof being the proof time, then baked.

A variant of the invention consists in using a direct combination of the five previously defined criteria and selecting strains that meet at least three of said criteria, and preferably four of said selection criteria.

The aforementioned hybridization and selection methods have led to the selection of three strains deposited in the CNCM under the numbers I-2971, I-3142 and I-3143.

Said three selected strains, and the other strains which are selectable by said hybridization and selection methods, make it possible to obtain, on the industrial scale, novel baker's yeasts having the properties defined by the selection criteria as compared with the baker's yeasts obtained with reference strain NCYC 996. In general, said novel baker's yeasts combining at least three properties corresponding to the selection criteria, and preferably four properties defined by the selection criteria, are obtained in the following manner with the novel yeast strains according to the invention.

Said yeast strains and the reference strain NCYC 996 were used to produce baker's yeasts in particular as described in the reference work entitled “Yeast Technology”, 2^{nd} edition, 1991, G. Reed and T. W. Nagodawithana, published by Van Nostrand Reinhold, ISBN 0-442-31892-8.

The production of baker's yeast comprises at least the first two steps of the following series of steps:
multiplication of a pure baker's yeast strain in several stages, first in semi-anaerobiosis, then in aerobiosis,
separation of the resulting baker's yeast from its culture medium by centrifugation, to obtain a liquid “yeast cream” containing approximately between 14 and 25% of dry matter content, or even a larger quantity of dry matter content if the yeast cream is mixed with osmotic products,
filtration of the liquid yeast cream so obtained, generally on a rotary vacuum filter, to obtain a dehydrated fresh yeast containing from 26% to 35% of dry matter content,
mixing of said dehydrated fresh yeast to produce a very homogeneous mass,
extrusion of the yeast so obtained and obtaining of a compressed yeast in the form of fresh yeast cakes or fresh yeast crumbs, commercialized with a dry matter content of approximately 30%, or, if the yeast is to be dried, in the form of particles, generally granules,
gentle drying of the yeast particles obtained by extrusion, in a current of hot air, for example by fluidization,
packaging.

Preferably, the novel yeasts according to the invention are adapted, during their final multiplication stage, to the stress due to the weak organic acids, by known methods, such as the method described in U.S. Pat. No. 4 ,318,991, with addition of 0.1 g to 10 g of short chain aliphatic carboxylic acids, such as aliphatic carboxylic acids having 2, 3 or 4 carbon atoms, and/or the salts thereof, per liter of wort. Said adaptation method can optionally be combined with a method of the type described in U.S. Pat. No. 4,346,115 in which, during the last cycle of multiplication of the yeast, a discontinuous flow of molasses is carried out, said discontinuous flow preferably being composed of brief interruptions, for example: flow of molasses for 5 to 10 minutes followed by interruptions of flow of 5 to 10 minutes.

In summary, the objects of the invention are:

each of the three novel strains deposited in the CNCM under the numbers I-2971, I-3142, I-3143.
strains belonging to the same family of said three strains, that is:
   strains that are obtainable by the same hybridization method and the same selection method as said three strains,
   strains sharing the same properties as said three strains.
strains obtained from one of the strains defined hereinabove, in particular by one or more hybridizations or by mutation.
novel baker's yeasts obtained by cultivating one of the strains defined hereinabove.
novel bread products obtained with the strains defined hereinabove.

TESTS A₅, A′₅, A₆, A′₆ DESCRIBED IN EP 0511108 AND U.S. Pat. No. 5,741,695 Tests A₅, A′₅, A₆, A′₆ used in the first criterion of the second selection were carried out with a Burrows and Harrison fermentor as described in the “Journal of Insitute of Brewing”, vol. LXV, No. 1, January-February 1959 and are precisely defined as follows:

Test A₅ (fresh compressed yeasts)

Saccharose (4 g) is added to 20 g of flour incubated at 30° C., then a weight of compressed yeast corresponding to 160 mg of dry matter content is added, said yeast having been diluted with 15 ml of water containing 27 g of NaCI per liter and 4 g of SO₄(NH₄)₂ per liter. The components are mixed with the aid of a spatula for 40 seconds to form a paste which is placed in a water-bath at 30° C. Thirteen minutes after the onset of mixing, the vessel containing the dough is sealed hermetically. The total quantity of gas produced is measured after 60 minutes and then after 120 minutes; this quantity is expressed in ml at 30° C. and under 760 mmHg.

For all the yeasts likely to show in 120 minutes a gas release greater than or equal to 150 ml of CO₂, the amount of fermentescible sugars solely provided by the flour is a limiting factor. Consequently, the test is modified as follows: a weight of yeast corresponding to 106 g of yeast dry matter content is used instead of 160 mg, and the reading of the quantity of gas produced is by convention multiplied by 1.5.

Test A′₅ (dry yeasts)

Identical to test A₅, but the 160 mg of yeast dry matter content which is in the form of active dry yeast are rehydrated for 15 minutes in distilled water at 38° C. prior to mixing. 40% of the volume of water of hydration employed is used for this purpose. The remaining water, to which 405 mg of NaCI are added, is added at the end of 15 minutes of rehydration.

Test A₆ (fresh compressed yeasts)

6.5 g of icing sugar and a weight of compressed yeast corresponding to 320 mg of yeast dry matter content are added to 25 g of flour incubated at 30° C.(instead of the 20 g of flour incubated at 30° C., the 4 g of saccharose and the weight of compressed yeast corresponding to 160 mg of yeast dry matter content in test A₅). This is followed by the same procedure as in test A₅.

Test A′₆ (dry yeasts)

This test is identical to test A₆, the 320 g of yeast dry matter content in the form of active dry yeast are rehydrated as in test A′₅.

DRYING CONDITIONS DISCLOSED IN THE TEACHINGS OF EP 0511108 and U.S. Pat. No. 5,741,695

For the first criterion of the second selection, the drying conditions are those disclosed in the teachings of EP 0511108 and U.S. Pat. No. 5,741,695.

To prepare the active dry yeast, the strains are cultivated in a concentrated medium, that is to say a medium whose total weight of wort at the end of culture in relation to the quantity of added molasses is of the order of 4.7 to 5.5 with an average hourly multiplication rate of the order of 1.17 to 1.18, so that compressed yeasts having a dry matter content of 30-35% are obtained, which have:
less than 5% of yeast buds,
a nitrogen content, based on the dry matter content, of the order of 7.9 to 8.3,
a P₂O₅ content, based on the dry matter content, of the order of 2.7 to 2.8,
a trehalose content, based on the dry matter content, of the order of 10 to 13%, preferably of the order of 12 to 13%.
   Said fresh yeast is dried by a gentle rapid drying process in the presence of an emulsifier, for example in the presence of 1.5% of sorbitan monostearate.

The following example serves as a non-limiting illustration of the invention and the advantages thereof.

### EXAMPLE

TESTS PT₁ and PT₂

Tests PT₁ and PT₂ were designed to measure, for a given bread-making method and with given recipes, the difference in proof time between an adapted fresh yeast obtained with the strain to be evaluated, and an adapted fresh yeast obtained with a reference strain on the other hand, both fresh yeasts being obtained by a same method of production.

The method of production of the adapted fresh baker's yeasts used in tests PT₁ and PT₂ corresponds to the classical method for the production of baker's yeast as described hereinabove, and in the final stage of culture comprises an adaptation to the stress due to the presence of weak organic acids according to the combined teachings of U.S. Pat. No. 4,318,991 and U.S. Pat. No. 4,346,115.

Said method for obtaining adapted fresh yeast having 32% of dry matter content was employed with the reference strain NCYC 996 (reference strain for the target application) and with the two novel strains I-2971 and I-3143.

The three fresh baker's strains with 32% of dry matter content obtained in this manner were used in tests PT₁ and PT₂ in a same bread-making method of the type No Time Dough.

Two different recipes were tested : in test PT₁, recipe 1 containing 25% of saccharose by mass (baker's percentage) and 0.4% of calcium propionate by mass (baker's percentage) and in test PT₂, recipe 2 containing 40% of saccharose by mass (baker's percentage).

Table 1 shows the recipes used in the two tests expressed as baker's percentages.

TABLE 1

| Ingredient | Recipe 1 (test PT₁) | Recipe 2 (test PT₂) |
|---|---|---|
| Flour | 100 | 100 |
| Water | 50 | 44 |
| Yeast | 6 | 9 |
| Fats | 7.5 | 7.5 |
| Improver | 1 | 1.5 |
| Saccharose | 25 | 40 |
| Salt | 1.7 | 1.7 |
| Calcium propionate | 0.4 | — |

The improver supplies a mixture of oxidizing and reducing agents, enzymes and classical emulsifiers allowing an optimization of the No Time Dough bread-making process, as well as good quality and good conservation of the bread so obtained.

The following test protocol was implemented in tests PT₁ and PT₂ on the two aforementioned recipes:
1. Weigh the 6 or 7 solid ingredients.
2. Measure the ambient temperature and the temperature of the flour.
3. Adjust the temperature of the water so as to obtain a dough temperature of 27° C.±0.5° C.
4. Place the ingredients in a MacDuffy® tank of a Hobart A200® kneader.
5. Mix slowly at the first speed for 1 minute.
6. Begin kneading according to the following program:
   a. first speed for 5 minutes
   b. rest for 5 minutes
   c. second speed for 5 minutes.
7. A dough is obtained having a temperature of 27° C.±0.5° C.
8. Bulk Fermentation at 23° C. for 10 minutes.
9. Divide into 320 g.dough pieces
10. Loose round and cover.
11. Rest for 10 minutes.
12. Dough shaping.
13. Place the 320 g dough pieces into pans (dimensions : base of pan 185×75 mm, top of pan 200×90 mm, height of pan 75 mm).
14. Measure the proof time in a Stericult® incubator with 90% relative humidity at 35° C. for test PT₁ and at 40° C. for test PT₂. The proof time is the time elapsed between placement of the dough in the incubator and rising to a height of 85 mm in the pan.
15. Bake in a Reed® tray oven at 190° C. for 22 minutes.
16. Measure the volume of the loaves after cooling for at least 1 hour and evaluate the scoring of bread so produced.

The differences in proof time between the adapted fresh yeast obtained from reference strain NCYC 996 on the one hand, and the adapted fresh yeasts obtained from strains CNCM I-2971 and I-3143 according to the invention, respectively, are given in Table 2 below.

TABLE 2

| | Recipe 1 (test PT₁) | Recipe 2 (test PT₂) |
|---|---|---|
| Fresh yeast reference | T | T |
| strain NCYC 996 | | |
| Fresh yeast strain CNCM | −11% | −25% |
| I-2971 | | |
| Fresh yeast strain CNCM | −5% | −35% |
| I-3143 | | |

Analogous results were obtained with the corresponding dry yeasts.

Tests PT₁ and PT₂ can also be used to select mutants or hybrids arising from strains I-2971,I-3142 and I-3143.

Thus, when the Saccharomyces cerevisiae strains according to the invention are strains obtained by one or more hybridizations of the three deposited strains cited hereinabove or strains obtained by one or more mutations of one of said strains, said strains (hybrids or mutants) are preferably strains which, in test PT₂, give a decrease in the proof time relative to reference strain NCYC 996 which is equal to at least 80% of the decrease in proof time obtained in test PT₂ with strain 1-2971 relative to said reference strain NCYC 996, preferably at least 85% and even more preferably at least 90% of the decrease in proof time obtained in test PT₂ with strain I-2971 relative to reference strain NCYC 996.

1-16. (canceled)

17. Strain of Saccharomyces cerevisiae deposited in the CNCM under the number I-2971 on 12 Feb. 2003.

18. Strain of Saccharomyces cerevisiae deposited in the CNCM under the number I-3142 on 25 Nov. 2003.

19. Strain of Saccharomyces cerevisiae deposited in the CNCM under the number I-3143 on 25 Nov. 2003.

20. Strain of Saccharomyces cerevisiae obtained by one or more hybridizations or by mutation of a strain according to claim 17.

21. Strain according to claim 20, which, in test PT₂, gives a decrease in the proof time relative to the reference strain NCYC 996 which is equal to at least 80% of the decrease in proof time obtained in test PT₂ with strain I-2971 according to claim 1 relative to said reference strain NCYC 996, preferably at least 85% and even more preferably at least 90% of the decrease in proof time obtained in test PT₂ with strain I-2971 relative to the reference strain NCYC 996.

22. Baker's yeast obtained by cultivating a strain according to claim 17 or 20.

23. Baker's yeast according to claim 22, obtained by cultivating the strain with adaptation to the presence of weak organic acids.

24. Baker's yeast according to claim 22, characterized in that the yeast is a yeast selected in the group consisting of yeast creams, compressed yeasts and dry yeasts.

25. Baker's yeast according to claim 24, characterized in that the yeast is a dry yeast, preferably an instant dry yeast.

26. Bread-making dough containing a baker's yeast according to claim 22.

27. Bread-making dough according to claim 26 in which fermentation takes place in the presence of an osmotic pressure such as that existing in doughs containing at least 15% of sugar relative to the mass of flour, preferably at least 25% of sugar relative to the mass of flour and even more preferably 40% or more sugar relative to the mass of flour.

28. Bread-making dough according to claim 27, characterized in that it contains mould inhibitors, preferably in the form of weak organic acids and/or the salts thereof, and more preferably in the form of propionates.

29. Method of preparation of a bread-making dough comprising the use of a yeast according to claim 22.

30. Method of preparation of a baked bread product comprising the baking of a bread-making dough according to claim 26.

31. Bread product obtainable by the method according to claim 30.

32. Bread-making dough containing a baker's yeast according to claim 23.

33. Bread-making dough according to claim 32 in which fermentation takes place in the presence of an osmotic pressure such as that existing in doughs containing at least 15% of sugar relative to the mass of flour, preferably at least 25% of sugar relative to the mass of flour and even more preferably 40% or more sugar relative to the mass of flour.

34. Bread-making dough according to claim 33, characterized in that it contains mould inhibitors, preferably in the form of weak organic acids and/or the salts thereof, and more preferably in the form of propionates.

35. Method of preparation of a bread-making dough comprising the use of a yeast according to claim 23.

36. Method of preparation of a baked bread product comprising the baking of a bread-making dough according to claim 32.

37. Bread product obtainable by the method according to claim 36.
